(19) United States
(12) Patent Application Publication
(10) Pub. No.: US 2026/0238643 A1
(43) Pub. Date: Aug. 13, 2026

(54) Systems and Methods for Verified Human Presence in Digital Interactions

(71) Applicants: Bradley Veazey, Amarillo, TX (US); Eduardo Fragoso, Amarillo, TX (US); Martin Lewis, Amarillo, TX (US)

(72) Inventors: Bradley Veazey, Amarillo, TX (US); Eduardo Fragoso, Amarillo, TX (US); Martin Lewis, Amarillo, TX (US)

(73) Assignee: BAM Enterprises of Amarillo LLC, Amarillo, TX (US)

(21) Appl. No.: 19/640,415

(22) Filed: Apr. 6, 2026

Related U.S. Application Data
(63) Continuation-in-part of application No. 19/051,164, filed on Feb. 11, 2025.
(60) Provisional application No. 63/783,937, filed on Apr. 4, 2025.
(60) Provisional application No. 63/795,201, filed on Apr. 25, 2025.
(60) Provisional application No. 63/805,132, filed on May 13, 2025.
(60) Provisional application No. 63/902,255, filed on Oct. 20, 2025.

(51) Int. Cl. H04L 9/40

(52) U.S. Cl. CPC H04L 63/0861

(57) ABSTRACT

A verified party transaction system verified party transaction system for managing secure financial transactions with biometric verification, the system is disclosed. Comprising a sender computer operated by a sender, the sender computer including: a memory, one or more processors, and communication hardware, configured to run a system application. A receiver computer operated by a receiver, the receiver computer including: the memory, the one or more processors, and the communication hardware, configured to run the system application. The transaction clearing system is configured for each user to: receiving personal details of the user, scanning a government-issued id of the user, capturing a facial image for biometric verification of the user, performing liveliness detection to confirm the presence of a live person of the user, and verifying and storing biometric data in the memory to create a profile for future transaction verifications.

### CROSS-REFERENCE TO RELATED APPLICATIONS

This application claims the benefit of U.S. Provisional Application No. 63/783,937, filed Apr. 4, 2025; U.S. Provisional Application No. 63/795,201, filed Apr. 25, 2025; U.S. Provisional Application No. 63/805,132, filed May 13, 2025; and U.S. Provisional Application No. 63/902,255, filed Oct. 20, 2025, each under 35 U.S.C. § 119(e), the entireties of which are incorporated herein by reference.

This application is also related to U.S. patent application Ser. No. 19/051,164, filed on Feb. 11, 2025, which claims the benefit of U.S. Provisional Application No. 63/608,728, filed on Dec. 11, 2023, under 35 U.S.C. § 119(e).

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Traditional transaction systems often depend on passwords, PINs, or device-based authentication to confirm a user's identity, but these methods are increasingly inadequate in the face of sophisticated fraud. Passwords can be stolen or guessed, and devices can be compromised or lost, leaving accounts vulnerable to unauthorized access. Additionally, many conventional systems fail to rigorously verify identity during account creation, allowing malicious actors to establish fraudulent accounts using stolen or counterfeit credentials. Such weaknesses are especially problematic in high-stakes contexts—like government fund distributions—where ensuring the authenticity of both the account holder and the transacting party is critical to prevent misappropriation and abuse.

The present invention overcomes these shortcomings by introducing a transaction system that integrates biometric verification and liveliness detection at every stage, from account setup to transaction authorization. By requiring a government-issued ID and a live facial scan during account creation, the system establishes a verifiable link between the account and its rightful owner, eliminating the possibility of impersonation at the outset. For each transaction, the system re-validates the user's identity using real-time biometric data, ensuring that only the original account holder can approve actions. This innovative approach provides a formidable barrier against fraud, impersonation, and unauthorized access, offering a secure and reliable solution for environments where identity assurance is paramount.

The Applicant is aware of JP2020526848A (User-Driven Identity Verification over the Network), which discloses a system wherein a user receives an authentication request from a relying party and responds by performing identity verification. However, the system disclosed in JP2020526848A is relying-party-initiated—the relying party originates the verification request and the user responds—and does not generate a portable, recipient-agnostic biometric presence assertion that can be independently verified without a real-time callback to the identity service. Additional prior art is disclosed in the Information Disclosure Statement filed herewith.

Beyond traditional credential theft, the rapid advancement of artificial intelligence has introduced new categories of identity threats that existing systems are unable to address. Deepfake technology can generate synthetic facial imagery sufficiently convincing to defeat conventional camera-based identity checks. Synthetic identity attacks combine real and fabricated personal information to create fraudulent accounts that pass traditional verification procedures. AI-generated voice cloning and behavioral mimicry further erode the reliability of single-factor and multi-factor authentication methods. These emerging attack vectors require a fundamentally different approach to verifying that a live human being is genuinely present during a digital interaction, as opposed to merely confirming that valid credentials have been presented.

Conventional identity verification systems further conflate two conceptually distinct security functions: authentication, which confirms that a user is who they claim to be, and presence, which confirms that a live human being is physically and actively engaged at the time of a digital action. Existing systems treat identity verification as a binary event tied to the lifecycle of an authentication session. Once a user authenticates, the session persists regardless of whether the authenticated human remains present at the device. This architectural gap is exploitable through session hijacking, replay attacks, automated scripts operating under authenticated sessions, and AI agents executing actions without contemporaneous human oversight. These vulnerabilities are particularly acute in contexts involving financial transactions, delegated authority, and AI-assisted decision-making, where the absence of a live human at the moment of action can result in unauthorized or unintended consequences.

The present invention further addresses these shortcomings by introducing a digital proof of human presence as an independent security object with its own lifecycle, distinct from and complementary to authentication credentials. This presence object is generated only upon successful real-time biometric verification and liveliness detection, is bound to a defined temporal window and a specific digital event, and expressly excludes biometric data from its contents. The presence object enables risk-adaptive verification that scales from low-risk actions requiring no presence verification to high-risk actions requiring bilateral, dual-party verified human presence. By decoupling presence from identity and from session state, the system creates a modular attestation primitive that can be consumed by transaction authorization systems, delegation frameworks, AI action authorization gates, and regulatory compliance systems without expanding the attack surface associated with identity data.

### BRIEF SUMMARY OF THE INVENTION

A system for managing digital proof of human presence, is disclosed that comprises one or more processors 112. One or more non-transitory computer-readable media 132 storing instructions that, when executed by the one or more processors 112, cause the system to: receive biometric input captured from a user device via a biometric input receiver 806. Perform, by a liveness determination engine 808, a liveness determination on the biometric input to determine that the biometric input was generated by a live human within a current time interval. Verify, by an identity verification engine 810, the biometric input against a previously validated digital identity record associated with a government-issued identity credential. Generate, by a presence generation module 804, upon successful liveness determination and identity verification, a digital proof of human presence represented as a presence object 802 distinct from authentication credentials, the presence object 802: being bound to a defined temporal validity window 812, being bound to at least one digital event identifier 814, and excluding biometric data and biometric templates. Store, transmit, or reference the presence object 802 independently of user authentication data. Manage, by a presence lifecycle manager 816, a lifecycle of the presence object 802 including issuance, validation, expiration, and revocation independent of authentication session management.

A computer-implemented method for authorizing execution of a digital action based on risk-adaptive verification of human presence, the method is disclosed that comprises receiving, by one or more processors 112, a request to execute a digital action. Determining, by a risk factor analyzer 904 executing on the one or more processors 112, a risk level associated with the requested digital action based on at least one risk factor. Selecting, by a presence level selector 906 based on the determined risk level, a required presence verification level comprising at least one of: no presence verification, single-party digital proof of human presence, or dual-party digital proof of human presence. Verifying a digital proof of human presence corresponding to the required presence verification level. Authorizing or denying execution of the digital action based on successful verification of the required presence verification level.

A computer-implemented method for verifying human presence while selectively withholding identity attributes, the method is disclosed that comprises generating, by one or more processors 112, a digital proof of human presence associated with a verified digital identity, said digital proof of human presence comprising a presence object 802 generated by said presence generation module 804 upon successful liveness determination by said liveness determination engine 808 and identity verification by said identity verification engine 810. Generating, by a presence assertion generator 1002, a presence assertion indicating verification of human presence without including personally identifiable information of the verified digital identity, said presence assertion being filtered by an identity attribute filter 1004 to exclude identity attributes. Transmitting the presence assertion to a relying system via a relying system interface 1006 for authorization of a digital action. Authorizing execution of the digital action by the relying system based on the presence assertion without disclosure of the personally identifiable information to the relying system.

### BRIEF DESCRIPTION OF THE SEVERAL VIEWS OF THE DRAWING

FIG. 1 illustrates an overview of a verified party transaction system 100.

FIG. 2 illustrates a flowchart of an account creation method 200 comprising several steps.

FIG. 3 illustrates a flowchart of a payment credential procedure 300 for associating payment credentials with a user.

FIG. 4 illustrates a sequence diagram of a transaction data flow procedure 400 between the one or more computers in said verified party transaction system 100.

FIG. 5 illustrates a flowchart of the transaction record finalization procedure 418.

FIG. 6 illustrates a flowchart of the account ledger system 416.

FIG. 7 illustrates a flowchart of the user verification procedure 406.

FIG. 8 illustrates a presence object generation and lifecycle management procedure 800 for generating and managing a digital proof of human presence within said verified party transaction system 100.

FIG. 9 illustrates a risk-adaptive presence escalation procedure 900 for dynamically adjusting the level of human presence verification required for a given operation within said verified party transaction system 100.

FIG. 10 illustrates a privacy-preserving presence assertion procedure 1000 for generating and transmitting proof of human presence to a relying system without disclosing the identity of the verified human.

FIG. 11 illustrates a presence-gated delegation and authority chain procedure 1100 for enabling a principal to delegate authority to a delegate entity while ensuring that the principal's verified human presence is required both at the time of delegation and at the time the delegated authority is exercised.

FIG. 12 illustrates a human-verified AI action authorization procedure 1200 for requiring verified human presence before an artificial intelligence system may execute, publish, or otherwise act upon its generated outputs within said verified party transaction system 100.

FIG. 13 illustrates an authority chart 1300 for said secure transaction system 100, which defines hierarchical relationships and authorization pathways among users.

FIG. 14 illustrates a handling reauthorization procedure 1400 for when a user fails the initial verification process in said secure transaction system 100, illustrated as a flow chart.

FIG. 15 illustrates an overview of a proof of human intention process 1500 integrated with said user authentication system 100 for AI interaction and prompting, such as in video meetings requiring real-time presence verification.

FIG. 16 illustrates an overview of a verified prompting process 1600 integrated with said user authentication system 100 for LLM prompting, ensuring proof of authentication in a step 1602.

FIG. 17 illustrates a two-sided credential issuance and verification process 1700 implemented within said user authentication system 100.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

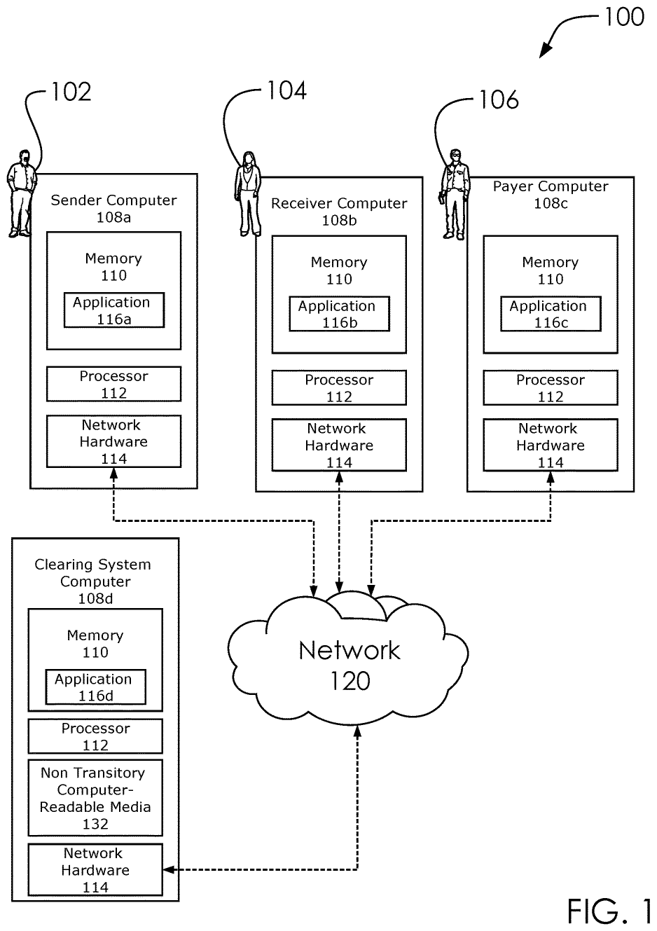

FIG. 1 illustrates an overview of a verified party transaction system 100.

In one embodiment, said verified party transaction system 100 can comprise a system for verifying a sender 102 and a receiver 104 of funds through secure verified procedures. Additionally, said verified party transaction system 100 can manage a payer 106. In some cases, said sender 102 and said payer 106 are the same entity. However, in scenarios involving government funds, said sender 102 may be an appointed government representative, and said payer 106 could be the government itself or a specific institution within the government. Furthermore, said verified party transaction system 100 can facilitate transactions where both said sender 102 and said receiver 104 are government representatives, transferring funds between departments or projects.

Said verified party transaction system 100 primarily comprises a relationship between two or more computers 108, each equipped with a memory 110, one or more processors 112, one or more non-transitory computer-readable media 132, and communication hardware 114. Said one or more non-transitory computer-readable media 132 store instructions that, when executed by the one or more processors 112, cause said computers 108 to perform the methods and procedures described herein. Specifically, said sender 102 can utilize the computers 108a, said receiver 104 can use the computers 108b, and said payer 106 can operate the computers 108c. Additionally, the computers 108d is included to manage verification processes. Each of these computers runs a system application 116 tailored to their respective roles. For instance, the system application on the computers 108a and the computers 108b have different functionalities due to their distinct roles in the financial transaction, while the computers 108c focuses on authenticating transactions and processing payments. the computers 108d ensures the authenticity of transactions and verifies the users involved.

All computers in said verified party transaction system 100 communicate over a network 120, which can include public and private networks, LANs, WANs, and the internet.

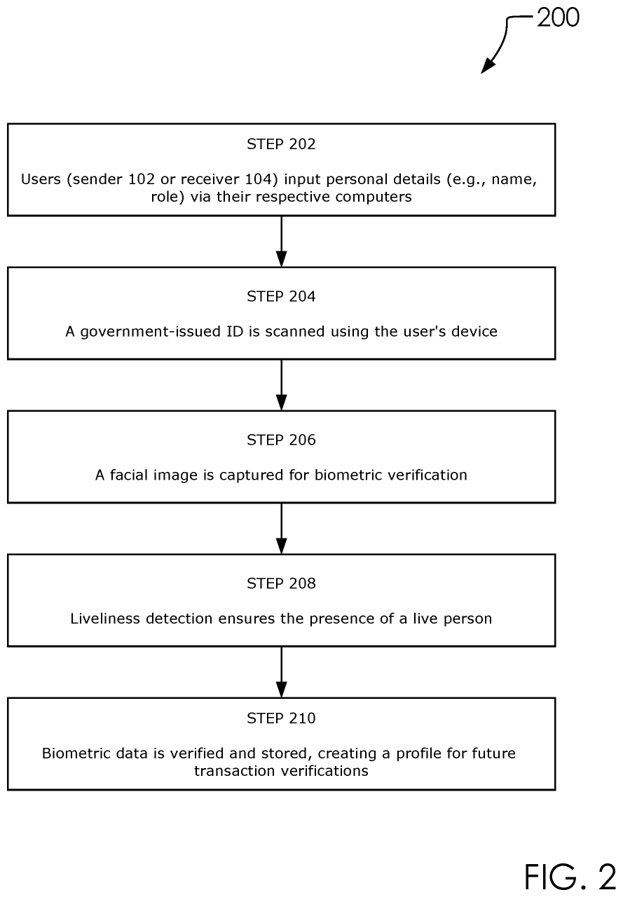

FIG. 2 illustrates a flowchart of an account creation method 200 comprising several steps.

In STEP 202, users, who can be either said sender 102 or said receiver 104, input personal details such as name and role via their respective computers, namely the computers 108a or the computers 108b. In STEP 204, a government-issued ID is scanned using the user's device. This step ensures that the user's identity is officially verified. In STEP 206, a facial image is captured for biometric verification. This image will be used to confirm the user's identity in future transactions. STEP 208 involves liveliness detection to ensure that a live person is present during the account creation process, thereby preventing fraudulent activities such as using a photograph or video to mimic a real person. Finally, in STEP 210, the biometric data, including the facial image and liveliness verification, is verified and stored, creating a profile that will be used for future transaction verifications. Additionally, during the account creation method 200, the system can associate the user's computer, such as said computers 108a or said computers 108b, with their account by recording a unique device identifier. This association ensures that future transactions are initiated from the registered device, adding an extra layer of security, as adapted from the parent application's emphasis on associating a specific device with a user during account setup.

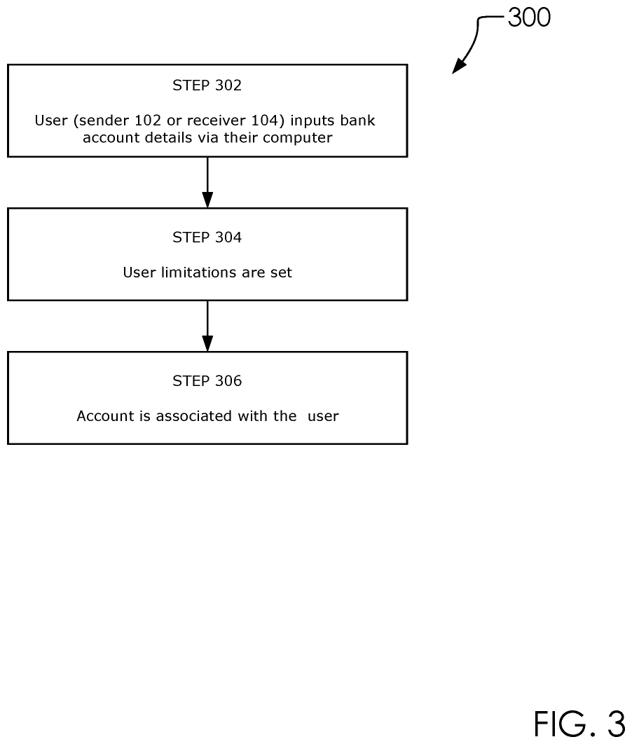

FIG. 3 illustrates a flowchart of a payment credential procedure 300 for associating payment credentials with a user.

In STEP 302, the user, who can be either said sender 102 or said receiver 104, inputs bank account details via their computer, such as said computers 108a or said computers 108b. This step allows the user to link their financial information to their account in said verified party transaction system 100.

In STEP 304, user limitations are set. These limitations could include transaction limits, spending caps, or other restrictions based on the user's role or regulatory requirements.

Finally, in STEP 306, the account is associated with the user, completing the setup of payment credentials.

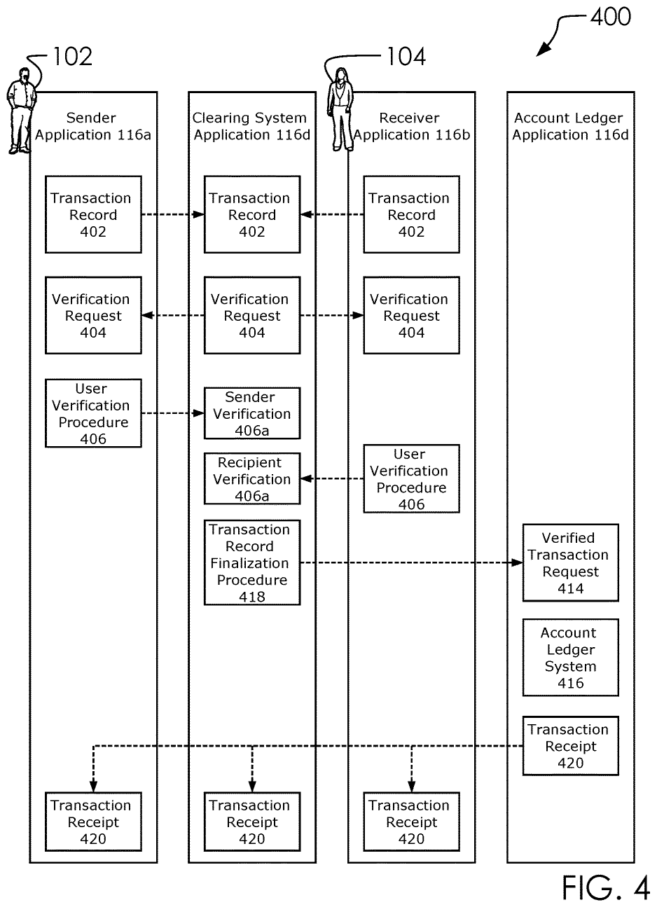

FIG. 4 illustrates a sequence diagram of a transaction data flow procedure 400 between the one or more computers in said verified party transaction system 100.

In this procedure, either said sender 102 or said receiver 104 can initiate the process by creating a transaction record 402. This transaction record is then transmitted to the computers 108d. Upon receiving said transaction record 402, said computers 108d sends a verification request 404 to both said sender 102 and said receiver 104.

In response, the system application 116 on said computers 108a conducts an user verification procedure 406 with said sender 102. Similarly, the system application 116 on said computers 108b conducts said user verification procedure 406 with said receiver 104. Each of these verification procedures generates an user verification record 408, which is sent back to said computers 108d.

Said computers 108d then combines said transaction record 402 with the user verification records from both parties, resulting in a verified transaction involving two authenticated parties. This combination enables auditing, confirmation, and accountability for the transaction.

In one embodiment, said transaction record 402 can comprise the user verification record 408 associated with said sender 102 and a funds recipient account 410 associated with said receiver 104. The primary objective of said verified party transaction system 100 is to create a verified transaction request 414 for use by an account ledger system 416.

A transaction record finalization procedure 418 aggregates all verifications and transaction parameters to prepare the data for said account ledger system 416. Subsequently, said transaction record 402 is sent to the system application 116d, which processes the transaction by moving or crediting funds and provides a transaction receipt 420.

Examples of said account ledger system 416 include banks, the Treasury Department, or similar entities in the federal government. The specifics of transaction clearing, whether by government or banking institutions, are well-known and not detailed here.

In some implementations, said verified party transaction system 100 can be used within a financial institution where all users are associated with the respective computers, meaning said computers 108d, said account ledger system 416, and each of the one or more computers 108 are operated by the same entity. Alternatively, the system can generate unique user identifications for use outside the financial institution, as is common in the financial industry.

To enhance auditing, images captured during said user verification procedure 406 can be associated with said transaction record 402. This feature addresses a significant issue in federal government transactions where authorizations to spend money may lack a traceable origin or recipient.

Recognizing that primary contacts for funding sources may sometimes be inaccessible or that authentication methods may fail, said verified party transaction system 100 allows for secondary and tertiary authenticated users for each funding source. This provision also accommodates situations where a user might be unable to use biometric scans due to injuries, such as facial burns or fingerprint damage, or when their appearance no longer matches their ID.

Additionally, each funding and recipient source can have an emergency delegate. The crucial aspect is that said verified party transaction system 100 can verify the parties associated with a transaction, both sender and receiver. In some cases, said user verification procedure 406 can also be applied to users at a financial institution, creating an additional point of contact and accountability for transactions.

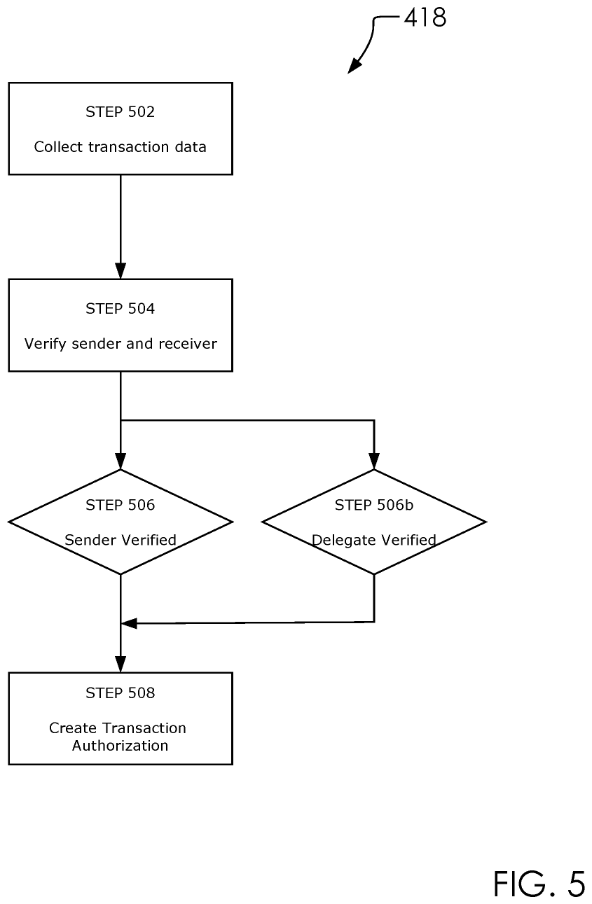

FIG. 5 illustrates a flowchart of the transaction record finalization procedure 418.

This procedure involves several steps to ensure the transaction is properly verified and authorized. In STEP 502, the system selects the transaction data, which likely includes details from said transaction record 402. In STEP 504, the system verifies both said sender 102 and said receiver 104, possibly by checking the user verification records received earlier. If the sender is verified in STEP 506, the process proceeds to STEP 508, where a transaction authorization is created. This authorization is a critical component of the verified transaction request 414, which is then used by the account ledger system 416 to process the transaction.

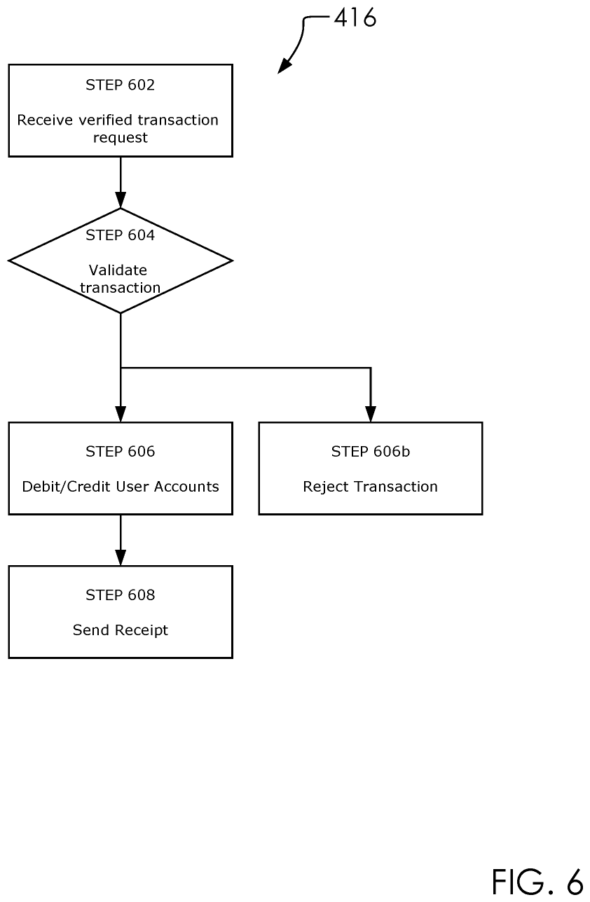

FIG. 6 illustrates a flowchart of the account ledger system 416.

This procedure is executed by the account ledger system 416 upon receiving the verified transaction request. In STEP 602, the system receives the verified transaction request 414. If the transaction is approved, the process moves to STEP 606, where the system debits and credits the appropriate user accounts, specifically debiting the funding source 408 associated with the sender 102 and crediting the funds recipient account 410 associated with the receiver 104. Following this, in STEP 608, the system sends a transaction receipt 420 to the relevant parties. If the transaction is not approved, the process branches to STEP 606b, where the transaction is rejected, and presumably, a notification is sent to the parties involved.

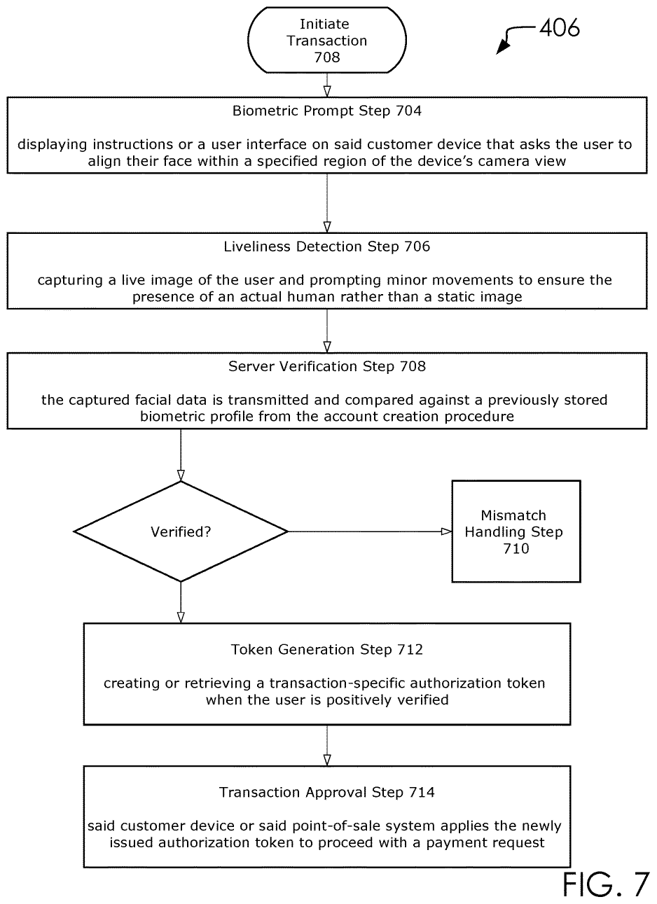

FIG. 7 illustrates a flowchart of the user verification procedure 406.

This procedure is crucial for ensuring that the user authorizing the transaction is indeed the legitimate party. In the Biometric Prompt Step 704, the system application 116 on the user's computer (either said sender computer 108a or said receiver computer 108b) displays instructions or a user interface that asks the user to align their face within a specified region of the device's camera view. This step initiates the biometric verification process.

In the Liveliness Detection Step 706, the system captures a live image of the user and prompts minor movements, such as blinking or turning the head, to ensure the presence of an actual human rather than a static image or video. This step prevents spoofing attempts.

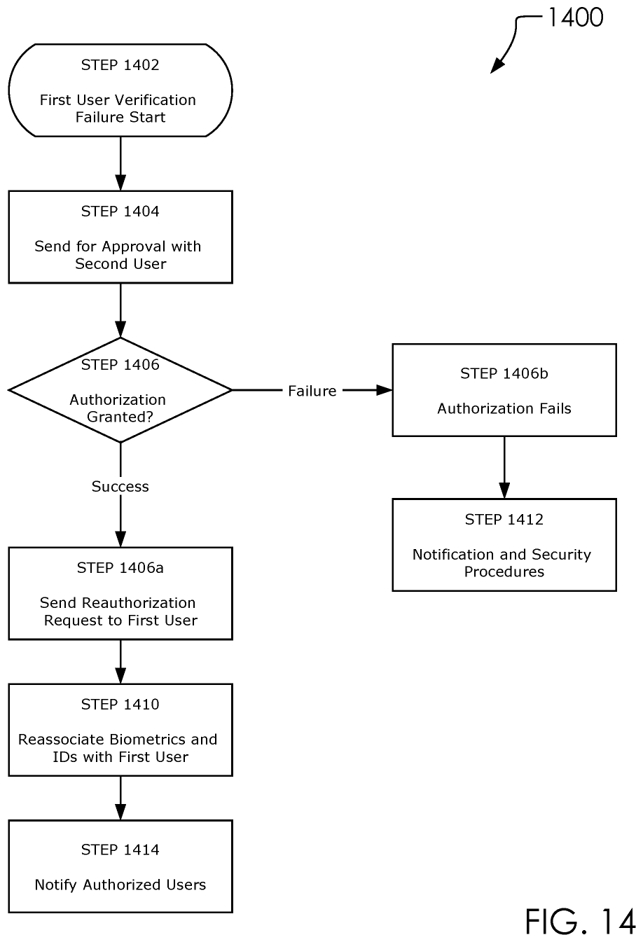

Following this, in the Server Verification Step 708, the captured facial data is transmitted to the transaction clearing system 108d, where it is compared against the previously stored biometric profile created during the account creation method 200. If the facial data matches the stored profile, the user is verified. If the facial data does not match, the system proceeds to a Mismatch Handling Step 710, which may trigger the handling reauthorization procedure 1400 described with reference to FIG. 14.

Upon successful verification, in the Token Generation Step 712, the system creates or retrieves a transaction-specific authorization token. This token is used to confirm the user's identity for the current transaction.

Finally, in the Transaction Approval Step 714, the user's computer (said sender computer 108a or said receiver computer 108b) applies the newly issued authorization token to proceed with the transaction request. This step ensures that only verified users can authorize transactions. Moreover, the system can verify that the transaction is being initiated from the registered device associated with the user's account, further confirming the authenticity of the transaction.

The verified party transaction system 100 is engineered to guarantee that the individual who establishes an account is the same person conducting each subsequent transaction, offering a powerful safeguard against fraud and identity theft. At the core of this system is an account creation process that mandates the submission of a government-issued ID paired with a live facial scan. This initial verification step ensures that the account is tied to the legitimate ID holder, thwarting attempts by imposters to sign up using stolen or fabricated credentials. The biometric data captured during this process—verified for liveliness to confirm the presence of a real person—is securely stored and serves as the foundation for all future transaction authentications.

When a transaction is initiated, the system activates the user verification procedure 406 that leverages real-time biometric matching and liveliness detection. Users are prompted to perform simple actions, such as blinking or turning their head, which are captured and analyzed to confirm their physical presence. This live biometric data is then matched against the stored profile from account setup, ensuring that only the original account holder can authorize transactions. Unlike traditional password-based systems, which can be compromised if credentials are stolen, this approach renders such attacks ineffective—knowledge of a password alone is insufficient without the account holder's unique biometric signature.

This dual-layer security framework delivers several critical advantages. First, it eliminates the risk of impersonation during account creation by anchoring the account to a verified government-issued ID and live biometric data. Second, it protects against unauthorized access, as even if someone obtains the account credentials or the registered device, they cannot bypass the biometric verification requirement. These features make the verified party transaction system 100 exceptionally robust, particularly for applications requiring high assurance of identity, such as government fund distributions or secure financial transactions, where confirming the authenticity of the transacting party is non-negotiable.

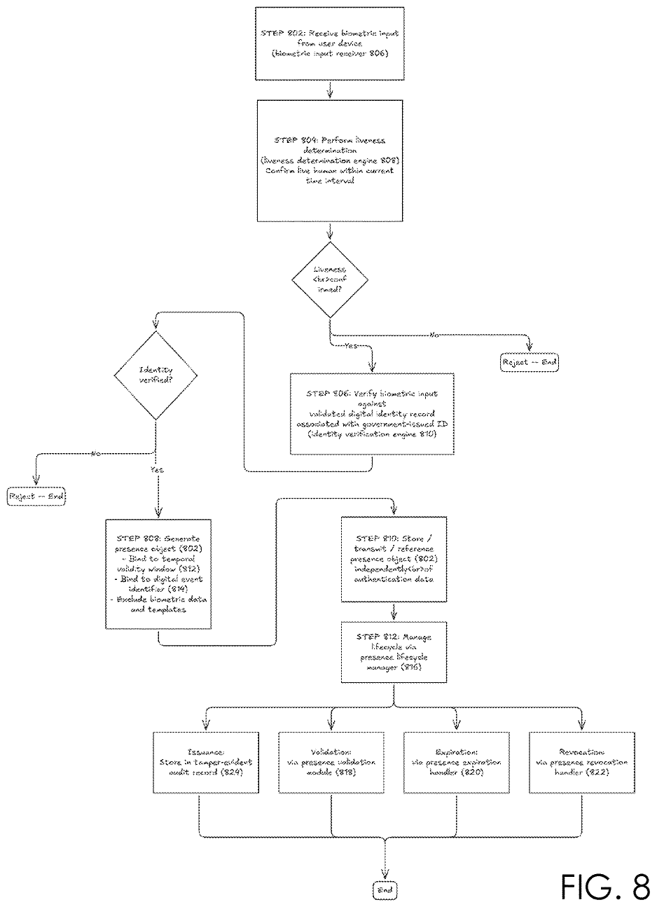

FIG. 8 illustrates a presence object generation and lifecycle management procedure 800 for generating and managing a digital proof of human presence within said verified party transaction system 100. Unlike the authorization token described with reference to FIG. 7, which is bound to an authentication session and confirms a user's identity for transaction approval, the presence object generation and lifecycle management procedure 800 produces a standalone cryptographic attestation that a specific human being was physically present at a specific time in connection with a specific digital event. Said presence object generation and lifecycle management procedure 800 operates independently of authentication credentials and session state, providing a discrete, verifiable assertion of human presence that can be consumed by any relying system without requiring access to the user's identity or authentication context.

In one embodiment, said presence object generation and lifecycle management procedure 800 comprises a presence generation module 804 executing on said computers 108d. Said presence generation module 804 orchestrates the generation, validation, and lifecycle management of a presence object 802. Said presence generation module 804 receives input from a biometric input receiver 806, which captures biometric data from the user via said computers 108a, said computers 108b, or said computers 108c. Said biometric input receiver 806 is configured to accept multiple biometric modalities, including but not limited to facial imagery, fingerprint scans, voice samples, and behavioral biometrics, and to transmit the captured biometric data to said presence generation module 804 for further processing.

At step 801, said biometric input receiver 806 captures biometric input from the user and transmits it to a liveness determination engine 808 within said presence generation module 804. Said liveness determination engine 808 performs liveness detection at step 802, analyzing the captured biometric data to confirm the physical presence of a living human being. Said liveness determination engine 808 employs anti-spoofing techniques including depth analysis, micro-movement detection, skin texture analysis, and challenge-response prompts to distinguish a live human from photographs, video replays, deepfakes, masks, or other synthetic representations. In some implementations, said liveness determination engine 808 applies a confidence scoring model that must exceed a configurable threshold before proceeding to subsequent steps.

At step 803, upon successful liveness determination, said presence generation module 804 transmits the biometric data to an identity verification engine 810. Said identity verification engine 810 compares the captured biometric data against stored biometric profiles established during said account creation method 200 to confirm the identity of the user. Said identity verification engine 810 operates in coordination with said computers 108d and may access biometric templates stored on a server 140. Upon successful identity verification, said identity verification engine 810 returns a verification confirmation to said presence generation module 804, whereupon the biometric data used for verification is discarded from working memory and is expressly excluded from the presence object 802 that will be generated in subsequent steps.

At step 804, said presence generation module 804 generates said presence object 802. Said presence object 802 comprises a cryptographically signed data structure that attests to the confirmed physical presence of a verified human at a specific point in time. Said presence object 802 includes a temporal validity window 812 that defines the time period during which said presence object 802 is considered valid. Said temporal validity window 812 is established at the moment of generation and expires after a predetermined duration, regardless of the state of any authentication session, login token, or other credential associated with the user. In one embodiment, said temporal validity window 812 is configurable based on the risk profile of the associated transaction or event, with higher-risk operations receiving shorter validity windows.

Said presence object 802 further includes a digital event identifier 814 that binds said presence object 802 to a specific digital event, transaction, or operation. Said digital event identifier 814 prevents reuse of said presence object 802 across unrelated events. For instance, the presence object 802 generated in connection with a funds transfer under said transaction data flow procedure 400 cannot be repurposed to authorize an unrelated delegation or policy change. Said digital event identifier 814 comprises a unique cryptographic hash derived from the event parameters, ensuring that any modification to the underlying event invalidates the binding between said presence object 802 and the event.

Critically, said presence object 802 does not contain biometric data, personally identifiable information, or identity attributes of the verified user. Said presence object 802 contains only: (a) a cryptographic attestation that a verified human was present, (b) said temporal validity window 812, (c) said digital event identifier 814, (d) a cryptographic signature generated by said presence generation module 804, and (e) a non-correlatable reference identifier. This design ensures that a relying system receiving said presence object 802 can verify that a human was present without learning the identity of that human, thereby preserving user privacy while satisfying presence verification requirements.

At step 805, said presence generation module 804 stores said presence object 802 and transmits it to the requesting system or application. In one embodiment, said presence object 802 is stored within said memory 110 of said computers 108d and is transmitted over said network 120 to the requesting computer. Said presence object 802 may be transmitted to said computers 108a, said computers 108b, or any other relying system that requires proof of human presence.

At steps 806 through 811, a presence lifecycle manager 816 manages the ongoing lifecycle of said presence object 802. Said presence lifecycle manager 816 comprises three subcomponents: a presence validation module 818, a presence expiration handler 820, and a presence revocation handler 822. Said presence validation module 818 receives validation requests from relying systems and verifies the cryptographic integrity, temporal validity, and event binding of said presence object 802. Said presence validation module 818 confirms that the cryptographic signature has not been tampered with, that the current time falls within said temporal validity window 812, and that the digital event identifier 814 matches the requesting event.

Said presence expiration handler 820 monitors the temporal validity window 812 of each outstanding presence object 802 and, upon expiration, marks the presence object 802 as expired and prevents further validation. Expiration occurs automatically and independently of the user's authentication session. A user may remain logged into said system application 116 with a valid session token, yet the presence object 802 associated with a specific event may have expired, requiring a new presence verification to proceed. This independence between authentication state and presence attestation is a fundamental architectural distinction from conventional session-based authorization systems.

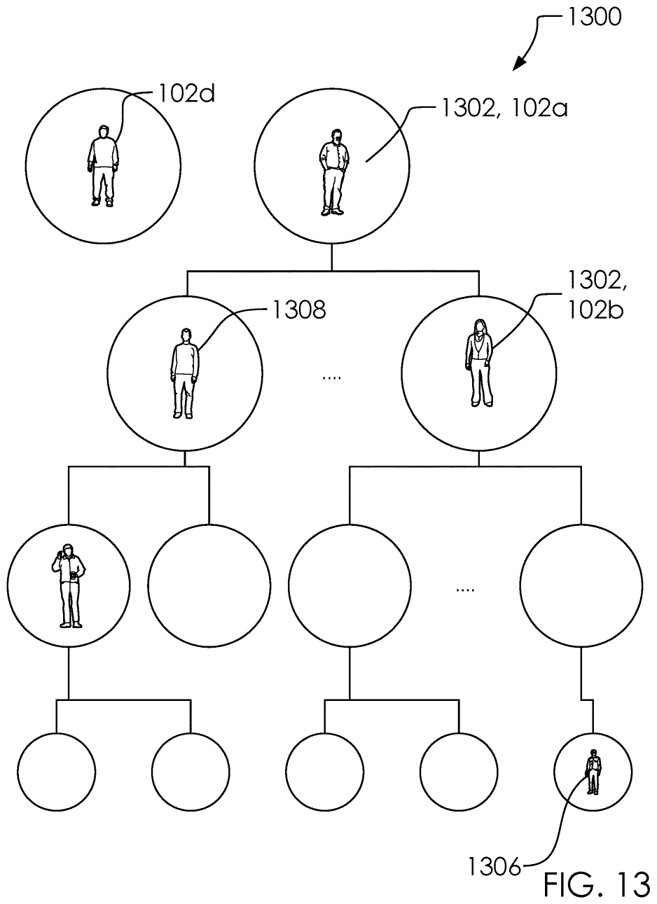

Said presence revocation handler 822 enables immediate invalidation of the presence object 802 prior to the natural expiration of said temporal validity window 812. Revocation may be triggered by the user, by a system administrator, by fraud detection systems, or by hierarchical authority as defined in an authority chart 1300 described with reference to FIG. 13. Upon revocation, said presence revocation handler 822 updates the lifecycle state of the presence object 802 and propagates the revocation status to all relying systems that have received or cached said presence object 802.

Each lifecycle event—generation, validation, expiration, and revocation—is recorded in a tamper-evident audit record 824. Said tamper-evident audit record 824 comprises a cryptographically chained log entry that records the event type, timestamp, the identity of the requesting system, and the outcome, without recording the identity of the verified human. Said tamper-evident audit record 824 is append-only and employs hash chaining such that any modification to a prior entry is detectable. In some implementations, said tamper-evident audit record 824 is stored on said server 140 and is accessible for audit, compliance, and dispute resolution purposes.

Said presence object generation and lifecycle management procedure 800 provides a foundational mechanism that enables the verified party transaction system 100 to assert and verify human presence independently of identity disclosure and independently of authentication session management. By decoupling presence from identity and from session state, the system creates a modular attestation primitive that can be consumed by transaction authorization procedures, delegation frameworks, AI action authorization gates, and regulatory compliance systems without expanding the attack surface associated with identity data. This architectural separation represents a significant advancement over conventional biometric authentication systems, which conflate the concepts of identity verification and presence attestation into a single operation.

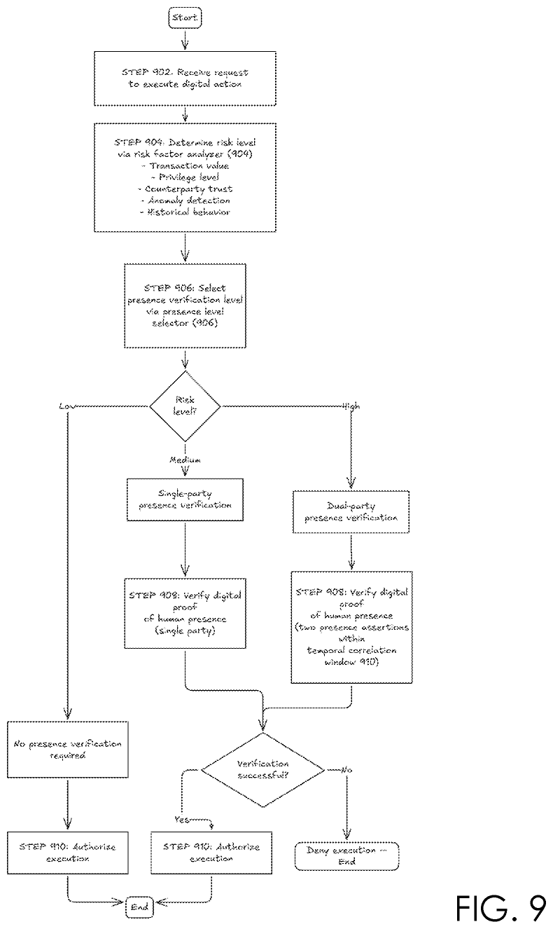

FIG. 9 illustrates a risk-adaptive presence escalation procedure 900 for dynamically adjusting the level of human presence verification required for a given operation within said verified party transaction system 100. Said risk-adaptive presence escalation procedure 900 evaluates the risk characteristics of each requested operation at execution time and selects the appropriate level of presence verification, ranging from no presence requirement to dual-party presence verification, ensuring that the verification burden is proportional to the risk of the operation.

In one embodiment, said risk-adaptive presence escalation procedure 900 comprises a risk evaluation engine 902 executing on said computers 108d. Said risk evaluation engine 902 receives a request to execute an operation, such as a funds transfer initiated under said transaction data flow procedure 400, a delegation request, or any other action mediated by said verified party transaction system 100. Said risk evaluation engine 902 intercepts the request prior to execution and performs a real-time risk assessment before determining the presence verification requirements.

Said risk evaluation engine 902 comprises a risk factor analyzer 904 that evaluates multiple risk dimensions associated with the requested operation. Said risk factor analyzer 904 analyzes factors including, but not limited to: the monetary value of the transaction, with higher-value transactions receiving higher risk scores; the privilege level of the requested operation, with administrative or policy-modifying actions receiving elevated risk scores; the trust level of the counterparty, with previously unverified or newly onboarded counterparties contributing to higher risk; anomaly indicators derived from deviation analysis against historical behavioral patterns of the requesting user; the geographic or device context of the request; and the time elapsed since the user's most recent successful presence verification.

Based on the composite risk assessment produced by said risk factor analyzer 904, a presence level selector 906 determines the required level of presence verification. Said presence level selector 906 applies one or more escalation thresholds 908 to map risk scores to presence levels. In one embodiment, said presence level selector 906 defines at least three presence levels: a first level requiring no presence verification, applicable to low-risk operations such as viewing account balances or reading transaction history; a second level requiring single-party presence verification, applicable to moderate-risk operations such as standard-value funds transfers where the requesting party must generate the presence object 802 pursuant to said presence object generation and lifecycle management procedure 800; and a third level requiring dual-party presence verification, applicable to high-risk operations such as large-value transfers, authority modifications, or operations involving untrusted counterparties, where both said sender 102 and said receiver 104 must each independently generate the presence object 802.

The dual-party presence verification required at the third level corresponds to and generalizes the bilateral sender-and-receiver verification described with reference to FIG. 4. In said transaction data flow procedure 400, said computers 108d sends said verification request 404 to both said sender 102 and said receiver 104, and both parties perform said user verification procedure 406. Said risk-adaptive presence escalation procedure 900 extends this concept by making dual-party verification a dynamically triggered requirement rather than a static protocol feature, and by defining the temporal constraints under which dual-party verification must occur.

Specifically, when dual-party presence is required, said risk-adaptive presence escalation procedure 900 enforces a temporal correlation window 910. Said temporal correlation window 910 defines the maximum permissible time interval between the generation of the first party's presence object 802 and the generation of the second party's presence object 802. Both presence assertions must be generated within said temporal correlation window 910 for the dual-party requirement to be satisfied. If the second party fails to generate a valid presence object 802 within said temporal correlation window 910, the first party's presence object 802 is deemed insufficient and the operation is denied. In some implementations, the duration of said temporal correlation window 910 is itself a function of the risk score, with higher-risk operations requiring shorter correlation windows to reduce the opportunity for coercion or manipulation between the two verification events.

Importantly, said risk evaluation engine 902 performs risk assessment at execution time, not at authentication time. A user who authenticated moments ago may still be required to generate a new presence object 802 if the risk profile of the specific operation being requested warrants it. Conversely, a user whose authentication session has been active for an extended period is not automatically denied access; rather, the risk assessment considers the totality of factors, including the staleness of the most recent presence attestation, in determining the appropriate verification level. This execution-time evaluation ensures that risk-proportional verification is applied to each discrete operation rather than to the session as a whole.

Upon determination of the required presence level, said risk-adaptive presence escalation procedure 900 communicates the requirement to the requesting computer and initiates the appropriate verification flow. If presence verification succeeds at the required level, the operation is authorized and proceeds. If presence verification fails or is not completed within the required timeframe, the operation is denied. In one embodiment, the denial is recorded in said tamper-evident audit record 824 together with the risk score and the required but unmet presence level, providing an auditable record of why the operation was blocked.

Said risk-adaptive presence escalation procedure 900 provides a significant architectural advantage by eliminating the binary choice between requiring presence verification for all operations and requiring it for none. By dynamically calibrating presence requirements to the actual risk of each operation, the system minimizes friction for routine low-risk activities while imposing rigorous human presence verification for high-risk actions. This risk-proportional approach aligns verification costs with the potential harm of unauthorized action, yielding a system that is both more secure and more usable than static verification schemes.

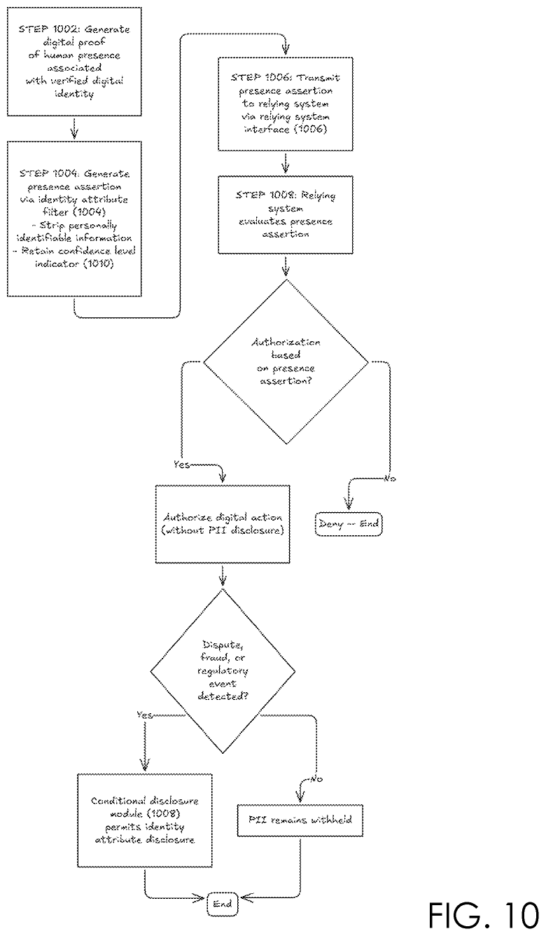

FIG. 10 illustrates a privacy-preserving presence assertion procedure 1000 for generating and transmitting proof of human presence to a relying system without disclosing the identity of the verified human. Said privacy-preserving presence assertion procedure 1000 enables said verified party transaction system 100 to satisfy presence verification requirements imposed by external or internal relying systems while preserving the privacy of the user and preventing cross-system identity correlation.

In one embodiment, said privacy-preserving presence assertion procedure 1000 comprises a presence assertion generator 1002 executing on said computers 108d. Said presence assertion generator 1002 receives the presence object 802 generated pursuant to said presence object generation and lifecycle management procedure 800 and produces a privacy-preserving assertion suitable for transmission to a relying system. Said presence assertion generator 1002 operates in conjunction with an identity attribute filter 1004 that systematically removes or redacts any information from which the identity of the verified human could be derived.

Said identity attribute filter 1004 strips from the assertion all personally identifiable information, biometric data, account identifiers, device identifiers, and any other attributes that could be used, individually or in combination, to identify or re-identify the verified user. Said identity attribute filter 1004 further applies cryptographic blinding techniques to ensure that the non-correlatable reference identifier included in the presence object 802 cannot be linked across separate assertions or across separate relying systems. Each assertion transmitted to a relying system contains a unique, single-use pseudonymous reference that cannot be correlated with references issued in connection with other assertions, even if the same human was verified in both instances.

The filtered assertion is transmitted via a relying system interface 1006 to the relying system that requested proof of human presence. Said relying system interface 1006 provides a standardized communication protocol through which relying systems submit presence verification requests and receive assertion responses. Said relying system interface 1006 is configured such that the relying system receives only the information necessary to confirm that a verified human was present—specifically, a confidence level indicator 1010 and the associated temporal validity window 812 and digital event identifier 814—without receiving any identity attributes or biometric data.

Said confidence level indicator 1010 conveys the strength of the presence verification without disclosing the verification methodology or the identity of the verified person. In one embodiment, said confidence level indicator 1010 comprises a numerical or categorical score indicating the confidence with which the system determined that a live human was present at the time of verification. The relying system may use said confidence level indicator 1010 to make authorization decisions, such as requiring a higher confidence level for higher-risk operations, without needing to know who the human was or how the verification was performed.

Said privacy-preserving presence assertion procedure 1000 further comprises a conditional disclosure module 1008 that governs the limited circumstances under which identity information associated with a presence assertion may be disclosed. Said conditional disclosure module 1008 permits disclosure of identity attributes only upon the occurrence of a predefined triggering condition, including but not limited to: a formal dispute filed by a party to the associated transaction, a fraud investigation initiated by said computers 108d or a designated administrator, or a regulatory or judicial requirement issued by a competent authority. In the absence of such a triggering condition, said conditional disclosure module 1008 prevents any disclosure of identity information, and the relying system has no mechanism to obtain or derive the identity of the verified human.

The design of said privacy-preserving presence assertion procedure 1000 ensures that the relying system cannot correlate presence assertions to identity records. Because each assertion contains a unique pseudonymous reference and because the identity attribute filter 1004 prevents transmission of correlatable attributes, a relying system that receives multiple assertions cannot determine whether they pertain to the same individual or to different individuals. This architectural constraint prevents the accumulation of behavioral profiles or identity graphs by relying systems, even if those systems aggregate assertions over time.

In some implementations, said privacy-preserving presence assertion procedure 1000 is designed to comply with applicable privacy regulations, including the General Data Protection Regulation (GDPR) of the European Union and the European Union Artificial Intelligence Act (EU AI Act). By ensuring that presence assertions do not constitute personal data within the meaning of such regulations—because they contain no information from which a natural person can be identified, directly or indirectly—said privacy-preserving presence assertion procedure 1000 enables the verified party transaction system 100 to operate across jurisdictions with stringent data protection requirements without triggering cross-border data transfer restrictions or data subject rights obligations in connection with presence verification activities.

Said privacy-preserving presence assertion procedure 1000 provides a critical privacy-preserving layer that enables the verified party transaction system 100 to satisfy the growing demand for proof of human presence in digital interactions without contributing to surveillance, identity aggregation, or privacy erosion. By architecturally separating the verification of presence from the disclosure of identity, the system enables trust without requiring transparency of the individual's identity to the relying party, a paradigm that is increasingly essential as automated systems and AI agents assume greater roles in digital transactions and decision-making processes.

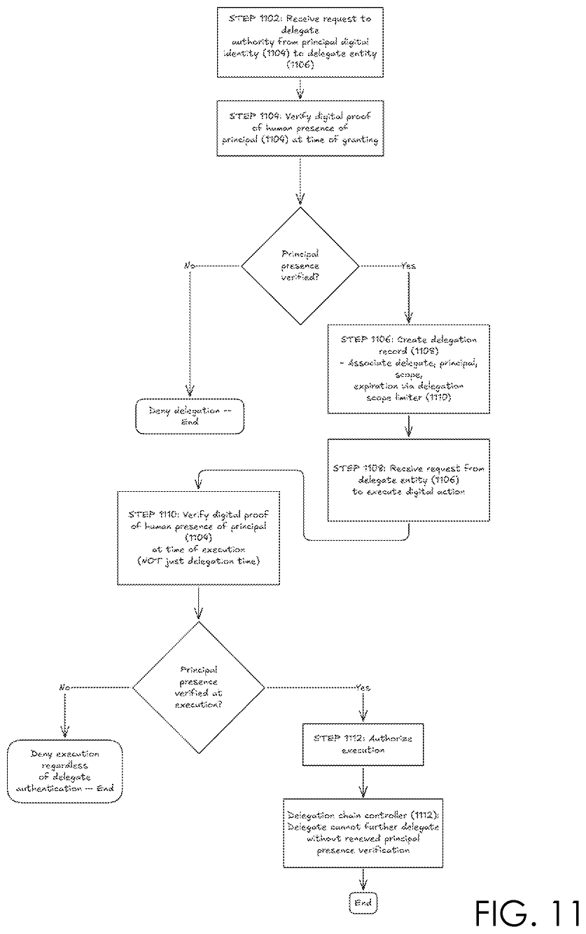

FIG. 11 illustrates a presence-gated delegation and authority chain procedure 1100 for enabling a principal to delegate authority to a delegate entity while ensuring that the principal's verified human presence is required both at the time of delegation and at the time the delegated authority is exercised. Said presence-gated delegation and authority chain procedure 1100 prevents the exercise of delegated authority when the delegating principal is no longer present, regardless of the delegate's own authentication or authorization status.

In one embodiment, said presence-gated delegation and authority chain procedure 1100 comprises a delegation module 1102 executing on said computers 108d. Said delegation module 1102 manages the creation, enforcement, and termination of delegation relationships. A principal digital identity 1104 represents the identity of the user who holds the authority being delegated, and a delegate entity 1106 represents the party to whom authority is being delegated. Said delegate entity 1106 may be a human user operating one of said computers 108, an automated software process, a software agent, or an artificial intelligence system. The nature of said delegate entity 1106 does not affect the requirement that said principal digital identity 1104 must demonstrate verified human presence at critical lifecycle points.

The procedure begins when said principal digital identity 1104 submits a delegation request to said delegation module 1102 via said system application 116. Upon receiving the delegation request, said delegation module 1102 initiates said presence object generation and lifecycle management procedure 800 for said principal digital identity 1104, requiring the principal to generate the presence object 802 that attests to the principal's physical presence at the time of delegation. If the principal fails to produce a valid presence object 802, the delegation request is denied and no delegation relationship is created.

Upon successful presence verification of the principal, said delegation module 1102 creates a delegation record 1108 that memorializes the delegation relationship. Said delegation record 1108 includes a reference to said principal digital identity 1104, a reference to said delegate entity 1106, a delegation scope limiter 1110 that defines the boundaries of the delegated authority, and an expiration parameter. Said delegation scope limiter 1110 constrains the types of operations, monetary limits, resource categories, and temporal boundaries within which the delegate entity 1106 may act on behalf of said principal digital identity 1104. Any operation requested by the delegate entity 1106 that falls outside the scope defined by said delegation scope limiter 1110 is automatically denied.

When said delegate entity 1106 subsequently requests execution of an operation within the delegated scope, said delegation module 1102 does not rely solely on the delegation record and the delegate's own credentials. Instead, said delegation module 1102 initiates a renewed presence verification for said principal digital identity 1104 at execution time. Said principal digital identity 1104 must generate a new presence object 802 that is temporally current and bound to the specific operation being requested via said digital event identifier 814. If said principal digital identity 1104 fails to generate a valid presence object 802 at execution time—whether because the principal is unavailable, unresponsive, or fails liveness verification—the requested operation is denied, regardless of the validity of the delegation record 1108 and regardless of the delegate's own authentication status.

This dual-gate requirement—presence at delegation time and presence again at execution time—ensures that delegation cannot be used as a mechanism to circumvent presence verification. A principal who delegates authority and subsequently becomes unavailable, incapacitated, or compromised cannot have that delegated authority exercised in the principal's absence. This design directly addresses the risk inherent in conventional delegation systems, where a delegation grant persists independently of the delegating party's ongoing consent and availability.

Said presence-gated delegation and authority chain procedure 1100 further comprises a delegation chain controller 1112 that governs the potential for sub-delegation. Said delegation chain controller 1112 prevents said delegate entity 1106 from further delegating the received authority to a third party unless said principal digital identity 1104 provides renewed verified presence specifically authorizing the sub-delegation. Said delegation chain controller 1112 thereby prevents the uncontrolled propagation of delegated authority through chains of sub-delegation, which in conventional systems can result in authority being exercised by parties far removed from the original principal's knowledge or consent.

Said presence-gated delegation and authority chain procedure 1100 integrates with said authority chart 1300 described with reference to FIG. 13 to provide hierarchical context for delegation relationships. Said delegation module 1102 may consult said authority chart 1300 to verify that said principal digital identity 1104 holds sufficient hierarchical authority to delegate the requested scope to said delegate entity 1106. In one embodiment, a primary user 1302 may delegate limited transactional authority to one of a secondary users 1304 or a tertiary users 1306, subject to the dual-gate presence requirement, and such delegation relationships are recorded within the hierarchical structure defined by said authority chart 1300.

Said presence-gated delegation and authority chain procedure 1100 provides a foundational mechanism for maintaining human oversight over automated and semi-automated processes within said verified party transaction system 100. By requiring the delegating principal's verified human presence at execution time, the system ensures that no operation is performed under delegated authority without contemporaneous human awareness and consent. This is particularly significant in environments where said delegate entity 1106 comprises an AI system or automated process, as it prevents autonomous action without a verified human principal actively overseeing the exercise of delegated authority.

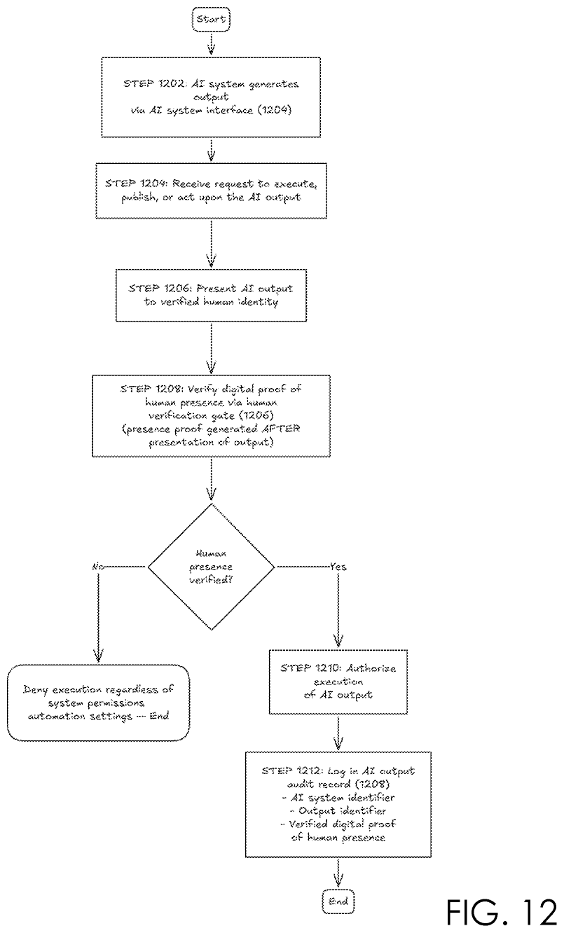

FIG. 12 illustrates a human-verified AI action authorization procedure 1200 for requiring verified human presence before an artificial intelligence system may execute, publish, or otherwise act upon its generated outputs within said verified party transaction system 100. Said human-verified AI action authorization procedure 1200 ensures that AI-generated outputs are subject to human review and that human presence is cryptographically verified after the output has been presented to the human, preventing both unauthorized autonomous AI action and rubber-stamp approval without genuine human engagement.

In one embodiment, said human-verified AI action authorization procedure 1200 comprises an AI output authorization module 1202 executing on said computers 108d. Said AI output authorization module 1202 interfaces with one or more AI systems via an AI system interface 1204. Said AI system interface 1204 receives AI-generated outputs from connected AI systems, including but not limited to large language models, decision-support engines, automated trading systems, policy recommendation engines, and content generation systems. When an AI system generates an output that requires action—such as publication, execution of a financial transaction, modification of a system policy, or allocation of system resources—the AI system submits the output to said AI output authorization module 1202 via said AI system interface 1204 together with a request to execute the proposed action.

Upon receiving the AI-generated output and the associated action request, said AI output authorization module 1202 presents the output to a designated human reviewer via said system application 116 on one of said computers 108. The presentation includes the full content of the AI-generated output, the proposed action, and the scope of the action's effects. Critically, said AI output authorization module 1202 does not request or accept human presence verification until after the output has been presented to the human. This sequencing is deliberate: a human verification gate 1206 is activated only after the human has had the opportunity to review the AI-generated output, ensuring that the presence attestation reflects presence during or after review rather than presence prior to or independent of the review.

Said human verification gate 1206 initiates said presence object generation and lifecycle management procedure 800 for the designated human reviewer, requiring the generation of the presence object 802 that is temporally bound to the review event via said digital event identifier 814. The digital event identifier 814 for this presence verification is derived from the specific AI output and proposed action, ensuring that the presence object 802 cannot be reused across different AI outputs or different proposed actions. If the human reviewer fails to generate a valid presence object 802—whether due to absence, failure of liveness verification, or refusal—the proposed action is denied and the AI-generated output is not executed, published, or acted upon.

The scope of actions governed by said human-verified AI action authorization procedure 1200 includes, but is not limited to: publication of AI-generated content to external systems or audiences; execution of financial transactions recommended or structured by AI systems; modification of system policies, access controls, or configuration parameters based on AI recommendations; allocation or reallocation of system resources, computing capacity, or network bandwidth directed by AI optimization engines; and transmission of communications drafted or composed by AI systems. Each of these action categories represents an area where autonomous AI action without human oversight presents material risk of harm, error, or unintended consequence.

If said human verification gate 1206 receives a valid presence object 802 from the human reviewer, said AI output authorization module 1202 authorizes the proposed action and permits execution. If the human reviewer affirmatively denies authorization—by interacting with said system application 116 to reject the proposed action—said AI output authorization module 1202 blocks execution regardless of any system permissions, automation settings, or AI confidence scores that might otherwise permit the action. In one embodiment, a denial issued through said human verification gate 1206 overrides all automated authorization pathways, ensuring that human judgment is the final arbiter of whether an AI-generated output may be acted upon.

Each authorization event, whether resulting in approval or denial, is recorded in an AI output audit record 1208. Said AI output audit record 1208 comprises a comprehensive log entry that records: the identity of the AI system that generated the output, as identified through said AI system interface 1204; the content or a cryptographic hash of the AI-generated output; the proposed action and its scope; the presence object 802 generated by the human reviewer, if any; the authorization decision (approved or denied); and the timestamp of the decision. Said AI output audit record 1208 is stored in a tamper-evident format consistent with said tamper-evident audit record 824 and provides a complete chain of evidence linking the AI system, its output, the human review, and the authorization decision.

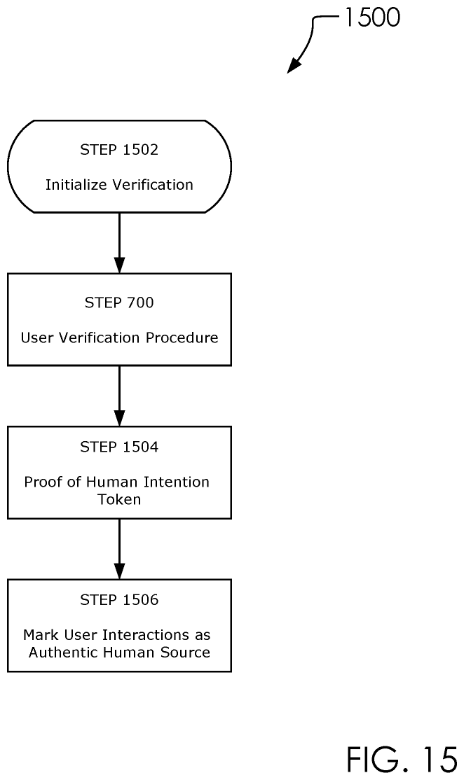

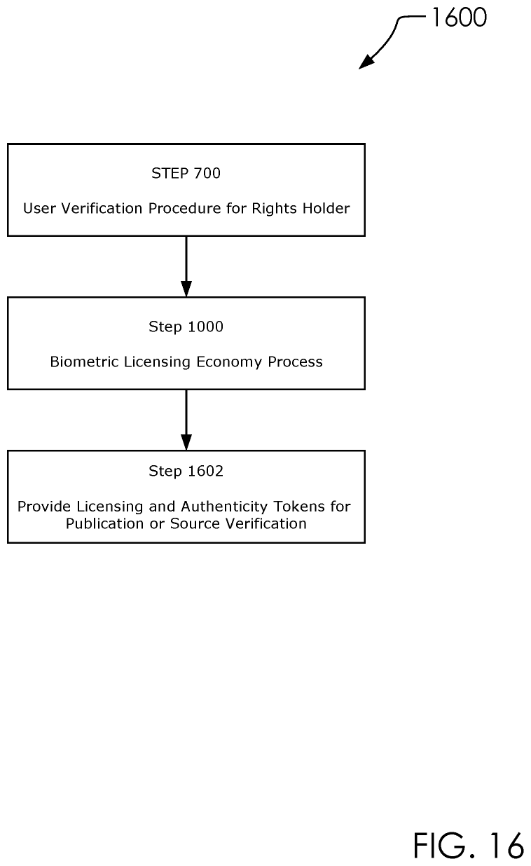

Said human-verified AI action authorization procedure 1200 integrates with a proof of human intention process 1500 described with reference to FIG. 15 and a verified prompting process 1600 described with reference to FIG. 16. While said proof of human intention process 1500 verifies human presence during real-time AI-assisted interactions and said verified prompting process 1600 ensures authenticated prompting of large language models, said human-verified AI action authorization procedure 1200 addresses the distinct requirement of verifying human presence and authorization at the point of AI output execution. Together, these three procedures provide comprehensive human presence verification across the full lifecycle of human-AI interaction: at input (prompting), during interaction (real-time presence), and at output (action authorization).

Said human-verified AI action authorization procedure 1200 provides a critical safeguard against the risks associated with autonomous AI action in high-stakes environments. As AI systems are increasingly deployed to generate recommendations, draft communications, structure transactions, and propose policy modifications, the risk of harm from unsupervised AI action grows correspondingly. By requiring verified human presence after presentation of AI output and before action execution, and by ensuring that human denial is architecturally superior to automated authorization, said human-verified AI action authorization procedure 1200 establishes a verifiable, auditable, and tamper-evident record that a specific AI action was authorized by a confirmed human being who had reviewed the output. This mechanism addresses emerging regulatory requirements, including provisions of the EU AI Act mandating human oversight of high-risk AI systems, and provides the evidentiary foundation necessary for legal and regulatory accountability in AI-assisted decision-making.

FIG. 13 illustrates the authority chart 1300 for said verified party transaction system 100, which defines hierarchical relationships and authorization pathways among users.

In one embodiment, the authority chart 1300 includes a top-level user, representing the user with the highest authority for specific resources. As illustrated, the top-level user comprise secondary users 1304.

Illustrated herein, the primary user 1302 comprises a user attempting to exercise authority over a resource. The resource is listed in a resources list 306, said primary user 1302 in an user accounts list 302, and said primary user 1302 is seeking to gain an authorization in a resource authorizations list 308. Said primary user 1302 thus initiates a step 506 of a redundancy test procedure 500. Details of verification of said primary user 1302 from a step 508 can be found in an user verification procedure 700 below.

As illustrated, said authority chart 1300 can resemble an organization chart (“org-chart”). In one embodiment, user confirmations can flow up or sidewise on said authority chart 1300 or possibly to one or more fail safe users among said sender 102. Wherein, if primary user 1302 fails to confirm his identity on said step 506 a party up said authority chart 1300 can confirm his identity.

In one embodiment, said verified party transaction system 100 can leverage this social dynamic to ensure that all users are verified initially and on an ongoing basis by ID and biometric confirmation, and in the case that biometric fails, by known parties on said authority chart 1300.

For discussion purposes and with reference to the example of said authority chart 1300, suppose that sender 102a comprises an executive officer of an organization, said primary user 1302 comprises a vice president level party in that organization. Suppose further that primary user 1302 fails a biometric verification in said step 508. Further, when primary user 1302 set up her account, she listed tertiary users 1306 as her failsafe contact. Upon failing verification, rather than signing into said verified party transaction system 100 and sending herself an email or SMS, said primary user 1302 can request approval from secondary users 1304 or said tertiary users 1306 to prove her identity. In yet another setting, if no one on her list is available, said sender 102d can be contacted to prover her identity.

Said authority chart 1300 can determine the escalation path when a user's verification fails in step 508. For instance, if said primary user 1302 fails verification, said verified party transaction system 100 may contact the secondary users 1304 for authorization. Escalation rules can prioritize contacting secondary users over tertiary users, with distant users serving as a last resort.

FIG. 14 illustrates a handling reauthorization procedure 1400 for when a user fails the initial verification process in said verified party transaction system 100, illustrated as a flow chart.

In one embodiment, the process begins at step 1402, where a first user fails the user verification procedure 700. Said verified party transaction system 100 then proceeds to step 1404, initiating secondary approval by contacting a second user, such as one of a secondary users 604 or a super user 610, as defined in an authority chart 600. At decision step 1406, the second user determines authorization. If approved, the process moves to decision step 1406a and then to step 1410, where the first user is reauthorized and invited to reenter biometric data and government ID to update the user accounts list 302. If not approved, the process proceeds to decision step 1406b and then to step 1412, where said verified party transaction system 100 may lock the account or notify other authorized users.

For significant resources, said verified party transaction system 100 can require the second user to be higher in said authority chart 600 or said super user 610, preventing unauthorized approvals. After successful reauthorization in step 1410, said verified party transaction system 100 may notify superior users and said super user 610 in step 1414, enhancing transparency and security.

Through this integrated approach, said verified party transaction system 100 leverages biometric verification and hierarchical authorization to ensure secure transactions and protect against fraud.

FIG. 15 illustrates an overview of the proof of human intention process 1500 integrated with said verified party transaction system 100 for AI interaction and prompting, such as in video meetings requiring real-time presence verification.

Said verified party transaction system 100 can further comprise said proof of human intention process 1500.

In one embodiment, said proof of human intention process 1500 introduces presence as a prerequisite for AI use and avatar behavior, ensuring real-time biometric confirmation for applications like Zoom AI avatars and real-time voice translation. Said proof of human intention process 1500 begins with an initiation step 1502, where a user engages with an AI-powered avatar that mimics facial expressions and translates speech. To address potential issues with lifelike avatars lacking confirmation of a real, present human, said verified party transaction system 100 performs a real-time biometric proof of presence check during the session, leveraging biometric data from said user accounts list 302 and said user verification procedure 700.

This check confirms that a real person is actively present, preventing avatar hijacking or synthetic participation. Upon successful verification, said proof of human intention process 1500 issues a proof of human intention token 1504 and applies a visible trust standard label 1506, such as “VULT ID—Verified Human with AI Assist,” and logs the biometric presence throughout the interaction via a server application 142.

Said proof of human intention process 1500 enhances security by tying AI interactions to ongoing liveliness and biometric matches, integrating with said authority chart 600 for hierarchical oversight.

FIG. 16 illustrates an overview of a verified prompting process 1600 integrated with said verified party transaction system 100 for LLM prompting, ensuring proof of authentication in a step 1602.

Said verified party transaction system 100 can further comprise said verified prompting process 1600.

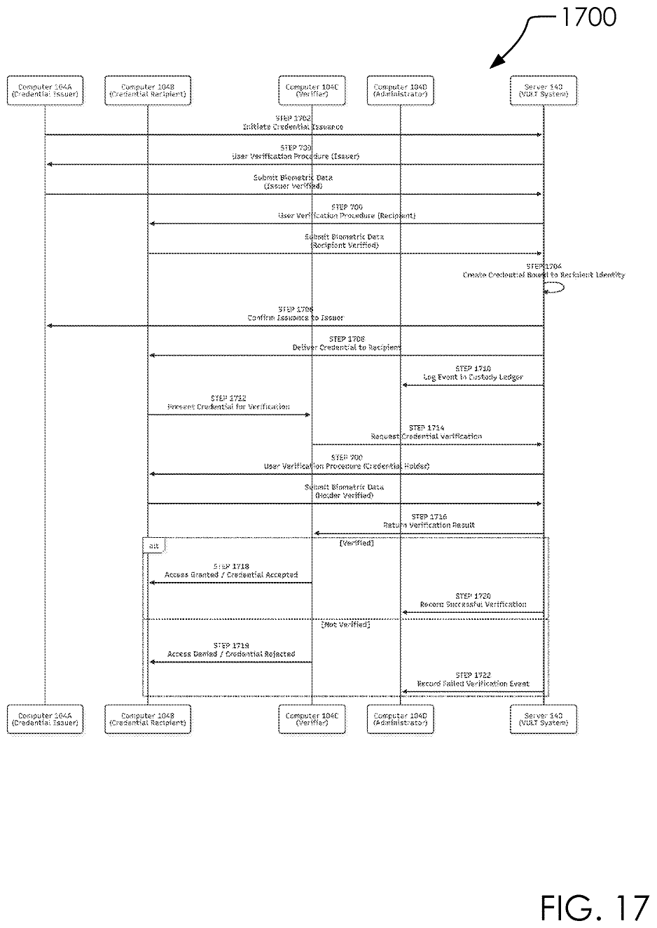

FIG. 17 illustrates a two-sided credential issuance and verification process 1700 implemented within said verified party transaction system 100.

Said two-sided credential issuance and verification process 1700 enables biometric verification of both a credential issuer and a credential recipient during issuance, as well as live presence verification of the credential holder during subsequent credential use. The system thereby ensures that issuance, transfer, and use of a credential are each bound to verified human identity.

In one embodiment, said two-sided credential issuance and verification process 1700 involves multiple system entities, including the receiver 104a functioning as a credential issuer terminal, the receiver 104b functioning as a credential recipient terminal, the receiver 104c functioning as a verifier terminal, the receiver 104d functioning as an administrator terminal, and said server 140 executing said server application 142 within said verified party transaction system 100.

At a step 1702, the receiver 104a initiates credential issuance through communication with said server 140. Upon initiation, said user verification procedure 700 is performed for the issuer to confirm the identity of the person authorized to issue the credential. Said user verification procedure 700 includes submission of biometric data to said server 140, which performs a biometric match 704 and a liveliness match 706 to confirm that the issuer is a live, authenticated individual. Upon successful verification, said server 140 designates the issuer as verified and proceeds to request verification of the intended recipient.

Said user verification procedure 700 is then executed for the credential recipient using the receiver 104b. The recipient submits biometric data to said server 140, and upon successful match confirmation, said server 140 creates the credential bound to the verified identity of the recipient at a step 1704. The credential may include a unique cryptographic identifier, hash, or signature derived from the recipient's verified identity and stored within said user accounts list 302.

Following credential creation, said server 140 confirms issuance to the issuer terminal at a step 1706 and delivers the credential to the recipient terminal at a step 1708. Said issuance event is logged at a step 1710 in a chain of custody record 310 or equivalent chain-of-custody record, recording the timestamp, credential ID, issuer ID, and recipient ID for auditability. the receiver 104d may access or monitor the issuance event for compliance verification.

When the credential is later used, said credential recipient or holder presents it for verification at a step 1712 using said receiver 104b, which communicates with the receiver 104c. The verifier requests credential verification from said server 140 at a step 1714. Said user verification procedure 700 is again executed for the credential holder to ensure live biometric presence at the time of use. Said holder submits biometric data to said server 140, which validates the credential and identity correspondence.

At a step 1716, said server 140 returns the verification result to said receiver 104c. If verified, the process proceeds to a step 1718, granting access or confirming credential acceptance. Said receiver 104d records a successful verification event at a step 1720, appending the result to the custody ledger.

If the credential or biometric verification fails, the process advances to a step 1719, denying access or rejecting the credential. Said receiver 104d then executes a step 1722, recording the failed verification event together with relevant metadata for investigation or audit review.

Through said two-sided credential issuance and verification process 1700, biometric verification is enforced at all stages of credential lifecycle—issuance, receipt, and use—ensuring non-transferability, authenticity, and a verifiable chain of custody. Said process further provides evidentiary-grade logging suitable for compliance, dispute resolution, and court-admissible proof of identity-bound credential control.

The following comprises a list of parts with reference to the original specification:
the verified party transaction system 100,
the sender 102,
the sender 102a,
the sender 102d,
the receiver 104,
the receiver 104a,
the receiver 104b,
the receiver 104c,
the receiver 104d,
the payer 106,
the computers 108,
the computers 108a,
the computers 108b,
the computers 108c,
the computers 108d,
the memory 110,
the one or more processors 112,
the one or more non-transitory computer-readable media 132,
the communication hardware 114,
the system application 116,
the system application 116d,
the network 120,
the server 140,
the server application 142,
the account creation method 200,
the payment credential procedure 300,
the user accounts list 302,
the resources list 306,
the resource authorizations list 308,
the chain of custody record 310,
the transaction data flow procedure 400,
the transaction record 402,
the verification request 404,
the user verification procedure 406,
the user verification record 408,
the funds recipient account 410,
the verified transaction request 414,
the account ledger system 416,
the transaction record finalization procedure 418,
the transaction receipt 420,
the redundancy test procedure 500,
the step 506,
the step 508,
the authority chart 600,
the secondary users 604,
the super user 610,
the user verification procedure 700,
the biometric match 704,
the liveliness match 706,
the presence object generation and lifecycle management procedure 800,
the presence object 802,
the presence generation module 804,
the biometric input receiver 806,
the liveness determination engine 808,
the identity verification engine 810,
the temporal validity window 812,
the digital event identifier 814,
the presence lifecycle manager 816,
the presence validation module 818,
the presence expiration handler 820,
the presence revocation handler 822,
the tamper-evident audit record 824,
the risk-adaptive presence escalation procedure 900,
the risk evaluation engine 902,
the risk factor analyzer 904,
the presence level selector 906,
the escalation thresholds 908,
the temporal correlation window 910,
the privacy-preserving presence assertion procedure 1000,
the presence assertion generator 1002,
the identity attribute filter 1004,
the relying system interface 1006,
the conditional disclosure module 1008,
the confidence level indicator 1010,
the presence-gated delegation and authority chain procedure 1100,
the delegation module 1102,
the principal digital identity 1104,
the delegate entity 1106,
the delegation record 1108,
the delegation scope limiter 1110,
the delegation chain controller 1112,
the human-verified AI action authorization procedure 1200,
the AI output authorization module 1202,
the AI system interface 1204,
the human verification gate 1206,
the AI output audit record 1208,
the authority chart 1300,
the primary user 1302,
the secondary users 1304,
the tertiary users 1306,
the handling reauthorization procedure 1400,
the step 1402,
the step 1404,
the decision step 1406,
the decision step 1406a,
the decision step 1406b,
the step 1410,
the step 1412,
the step 1414,
the proof of human intention process 1500,
the initiation step 1502,
the proof of human intention token 1504,
the visible trust standard label 1506,
the verified prompting process 1600,
the step 1602,
the two-sided credential issuance and verification process 1700,
the step 1702,
the step 1704,
the step 1706,
the step 1708,
the step 1710,
the step 1712,
the step 1714,
the step 1716,
the step 1718,
the step 1719,
the step 1720,
the step 1722, and
the verified prompting process 1600.

The following comprises one preferred embodiment with with reference to the original claims.

A system for managing digital proof of human presence, can comprise one or more processors 112. One or more non-transitory computer-readable media storing instructions that, when executed by the one or more processors 112, cause the system to: receive biometric input captured from a user device via the biometric input receiver 806. perform, by the liveness determination engine 808, a liveness determination on the biometric input to determine that the biometric input was generated by a live human within a current time interval. verify, by the identity verification engine 810, the biometric input against a previously validated digital identity record associated with a government-issued identity credential. generate, by the presence generation module 804, upon successful liveness determination and identity verification, a digital proof of human presence represented as the presence object 802 distinct from authentication credentials, the presence object 802: being bound to a defined temporal validity window 812, being bound to at least one digital event identifier 814, and excluding biometric data and biometric templates. store, transmit, or reference the presence object 802 independently of user authentication data. manage, by the presence lifecycle manager 816, a lifecycle of the presence object 802 including issuance, validation, expiration, and revocation independent of authentication session management.

A computer-implemented method for authorizing execution of a digital action based on risk-adaptive verification of human presence, the method can comprise receiving, by one or more processors 112, a request to execute a digital action. determining, by the risk factor analyzer 904 executing on the one or more processors 112, a risk level associated with the requested digital action based on at least one risk factor. selecting, by the presence level selector 906 based on the determined risk level, a required presence verification level comprising at least one of: no presence verification, single-party digital proof of human presence, or dual-party digital proof of human presence. verifying a digital proof of human presence corresponding to the required presence verification level. authorizing or denying execution of the digital action based on successful verification of the required presence verification level.

A computer-implemented method for verifying human presence while selectively withholding identity attributes, the method can comprise generating, by one or more processors 112, a digital proof of human presence associated with a verified digital identity, said digital proof of human presence comprising the presence object 802 generated by said presence generation module 804 upon successful liveness determination by said liveness determination engine 808 and identity verification by said identity verification engine 810. generating, by the presence assertion generator 1002, a presence assertion indicating verification of human presence without including personally identifiable information of the verified digital identity, said presence assertion being filtered by the identity attribute filter 1004 to exclude identity attributes. transmitting the presence assertion to a relying system via the relying system interface 1006 for authorization of a digital action. authorizing execution of the digital action by the relying system based on the presence assertion without disclosure of the personally identifiable information to the relying system.

### Biometric-Gated AI Content Generation Consent

In a further embodiment, said verified party transaction system 100 further comprises a biometric-gated AI content generation consent mechanism. Before an AI content generation system is permitted to produce output incorporating a registered individual's biometric attributes—including facial likeness, voice characteristics, or other identity-linked features—the system requires a real-time, server-side biometric proof-of-presence event from that individual. This is structurally distinct from contractual consent (written consent forms), credential-based consent (OAuth tokens, API keys), or device-local consent (on-device biometric gates), none of which can confirm that the consenting person is physically present and alert at the moment the generation occurs.

In one implementation, a content generation request references a registered identity anchor associated with the individual whose attributes are to be used. The system queries said presence generation module 804 for a live biometric consent event for that identity. Said presence generation module 804 initiates a real-time verification challenge to the registered individual via said biometric input receiver 806, said liveness determination engine 808, and said identity verification engine 810. Upon successful verification, the system generates a single-use, time-bounded consent token that is cryptographically bound to the specific generation request parameters—the permitted content type, medium, duration, and distribution channel. The consent token cannot be reused for a different generation request. The content generation system proceeds only within the scope and duration of the consent token. Upon expiration of the time window or completion of the authorized generation event, whichever occurs first, the consent token is invalidated.

In some implementations, the system maintains an immutable audit log of all generation consent events, recording the requesting system identifier, the generation parameters, the verification timestamp, and the consent token identifier. The registered individual can access this audit log via biometric re-authentication to review all consent events associated with their identity.

In a further implementation, a posthumous consent authority designation stored in association with the individual's identity anchor may be activated upon biometric verification of a designated estate authority, enabling generation consent to be granted on behalf of a deceased individual by the designated authority. The posthumous consent authority operates through the same biometric verification and consent token mechanism, with the designated authority's biometric anchor substituted for the original individual's anchor for authorization purposes.

### Biometric Identity Presence Record for Legal Instruments

In a further embodiment, said verified party transaction system 100 further comprises a mechanism for generating a court-admissible biometric identity presence record—a cryptographically sealed package that proves a specific verified, living human being was present at the moment a legal instrument was executed, with a tamper-evident chain of custody from that moment forward.

The mechanism operates as follows. A biometric proof-of-presence verification is performed via said presence generation module 804, and a liveness confidence score, biometric anchor match result, and duress signal vector are recorded. The verification event produces a signed biometric presence attestation—a structured data object incorporating the biometric match result, liveness confirmation, a unique verification session identifier, an identity anchor reference, and a verified timestamp. The attestation is digitally signed within a hardware security module. The signed attestation is then submitted to an RFC 3161-compliant Timestamp Authority for qualified timestamping, producing a qualified timestamp token that cryptographically binds the attestation to a verified UTC timestamp. The resulting package—comprising the HSM-signed biometric attestation and the RFC 3161 timestamp token—constitutes the biometric identity presence record.

The biometric identity presence record is written to said tamper-evident audit record 824 and is provided as a self-contained, independently verifiable package proving both the temporal occurrence of the verification event and the biometric presence of the verified individual at that time. Any party holding the HSM public key and access to the RFC 3161 issuing authority's public certificate can independently verify the record without requiring a real-time callback to the system.

In some implementations, the duress signal vector is incorporated into the biometric presence attestation and is verifiable by an authorized party, enabling post-hoc detection of a verification ceremony performed under coercion. In further implementations, the biometric identity presence record is associated with a specific legal instrument identifier, such that the record constitutes machine-verifiable proof that the individual was present and verified at the time the instrument was executed. The biometric identity presence record may be structured to comply with Federal Rules of Evidence 901 (authentication) and 902 (self-authentication) through its combination of qualified timestamp, HSM digital signature, and biometric liveness attestation.

### Consumer-Initiated Biometric Verification Request

In a further embodiment, said verified party transaction system 100 further comprises a consumer-initiated biometric verification mechanism that inverts the conventional relying-party-initiated verification model. Rather than a service or institution requesting verification of a consumer, the consumer initiates the verification event and pushes a signed biometric presence assertion outward to a recipient of the consumer's choosing.

In this embodiment, a consumer initiates a verification event from their enrolled identity within said verified party transaction system 100. The consumer completes a live biometric verification via said presence generation module 804 against their server-side biometric anchor. Upon successful verification, the system generates a consumer-issued biometric presence assertion—a signed, time-bounded, scoped credential proving that a specific verified identity was live-verified at a specific moment. The assertion is returned to the consumer, who transmits it to a recipient—a person, institution, or platform—through any channel, including QR code, deep link, NFC tap, or direct message. The recipient verifies the assertion against a published public key without a real-time callback to said verified party transaction system 100. The assertion expires after a defined time window and cannot be reused.

The consumer-issued biometric presence assertion includes a scope parameter specifying one or more identity attributes the consumer authorizes to be disclosed to the recipient. No attribute outside the specified scope is accessible to the recipient from the assertion. In some implementations, the consumer specifies a recipient identifier in the scope parameter, such that the assertion is cryptographically bound to a specific recipient and cannot be verified by any other party. In other implementations, the assertion is recipient-agnostic and verifiable by any party holding the published public key.

This consumer-initiated model is structurally distinct from relying-party-initiated flows such as those disclosed in JP2020526848A, wherein a relying party originates a verification request and the user responds. In the present embodiment, the consumer originates the entire flow without a prior request from any relying party, and the resulting assertion is portable, recipient-agnostic, and biometrically anchored rather than credential-based.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for managing digital proof of human presence, comprising:
one or more processors; and
one or more non-transitory computer-readable media storing instructions that, when executed by the one or more processors, cause the system to:
receive biometric input captured from a user device via a biometric input receiver;
perform, by a liveness determination engine, a liveness determination on the biometric input to determine that the biometric input was generated by a live human within a current time interval;
verify, by an identity verification engine, the biometric input against a previously validated digital identity record associated with a government-issued identity credential;
generate, by a presence generation module, upon successful liveness determination and identity verification, a digital proof of human presence represented as a presence object distinct from authentication credentials, the presence object:
being bound to a defined temporal validity window,
being bound to at least one digital event identifier, and
excluding biometric data and biometric templates;
store, transmit, or reference the presence object independently of user authentication data; and
manage, by a presence lifecycle manager, a lifecycle of the presence object including issuance, validation, expiration, and revocation independent of authentication session management.

2. The system of claim 1, wherein the presence object is reusable for authorizing multiple digital events occurring within the defined temporal validity window.

3. The system of claim 1, wherein the presence object is rendered invalid upon expiration of the defined temporal validity window regardless of authentication session state.

4. The system of claim 1, wherein the lifecycle management by said presence lifecycle manager comprises revoking the presence object in response to detection of a biometric mismatch or liveness failure by said liveness determination engine.

5. The system of claim 1, wherein the presence object is associated with a unique identifier and stored in a tamper-evident audit record.

6. The system of claim 1, wherein validation of the presence object by a presence validation module is performed independently of credential-based authentication.

7. The system of claim 1, wherein the presence object is referenced by a risk evaluation engine to determine whether execution of a requested digital action is permitted.

8. The system of claim 1, wherein the presence object is generated without persistent storage of biometric data beyond completion of the liveness determination by said liveness determination engine.

9. A computer-implemented method for authorizing execution of a digital action based on risk-adaptive verification of human presence, the method comprising:
receiving, by one or more processors, a request to execute a digital action;
determining, by a risk factor analyzer executing on the one or more processors, a risk level associated with the requested digital action based on at least one risk factor;
selecting, by a presence level selector based on the determined risk level, a required presence verification level comprising at least one of:
no presence verification,
single-party digital proof of human presence, or
dual-party digital proof of human presence;
verifying a digital proof of human presence corresponding to the required presence verification level; and
authorizing or denying execution of the digital action based on successful verification of the required presence verification level.

10. The method of claim 9, wherein the at least one risk factor comprises at least one of transaction value, privilege level, counterparty trust, anomaly detection output, or historical behavior.

11. The method of claim 9, wherein the required presence verification level escalates as the determined risk level increases according to one or more escalation thresholds.

12. The method of claim 9, wherein the digital proof of human presence comprises a presence object having a defined temporal validity window, said presence object being generated pursuant to said presence generation module and being distinct from authentication credentials.

13. The method of claim 9, wherein the required presence verification level comprising dual-party digital proof of human presence requires verification of presence assertions associated with two distinct verified digital identities.

14. The method of claim 13, wherein the two presence assertions are generated within a defined temporal correlation window.

15. The method of claim 9, wherein the risk level is evaluated at execution time of the digital action rather than at authentication time.

16. A computer-implemented method for verifying human presence while selectively withholding identity attributes, the method comprising:
generating, by one or more processors, a digital proof of human presence associated with a verified digital identity, said digital proof of human presence comprising a presence object generated by said presence generation module upon successful liveness determination by said liveness determination engine and identity verification by said identity verification engine;
generating, by a presence assertion generator, a presence assertion indicating verification of human presence without including personally identifiable information of the verified digital identity, said presence assertion being filtered by an identity attribute filter to exclude identity attributes;
transmitting the presence assertion to a relying system via a relying system interface for authorization of a digital action; and
authorizing execution of the digital action by the relying system based on the presence assertion without disclosure of the personally identifiable information to the relying system.

17. The method of claim 16, wherein the presence assertion includes a confidence level indicator indicating a level of confidence of human presence without revealing identity attributes of the verified digital identity.

18. The method of claim 16, wherein disclosure of identity attributes of the verified digital identity is conditionally permitted only upon detection of a dispute, fraud event, or regulatory requirement, via a conditional disclosure module.

19. The method of claim 16, wherein the presence assertion is cryptographically verifiable by the relying system without access to underlying biometric data.

20. The method of claim 16, wherein the relying system is prohibited from correlating the presence assertion to an identity record of the verified digital identity absent explicit authorization.
